(19) United States
(12) Patent Application Publication
(10) Pub. No.: US 2026/0023528 A1
(43) Pub. Date: Jan. 22, 2026

(54) MULTIPLEXOR FOR A PROCESSING UNIT OF MEMORY

(71) Applicant: Micron Technology, Inc., Boise, ID (US)

(72) Inventors: Glen E. Hush, Boise, ID (US); Peter L. Brown, Eagle, ID (US)

(21) Appl. No.: 19/225,556

(22) Filed: Jun. 2, 2025

Related U.S. Application Data
(60) Provisional application No. 63/672,124, filed on Jul. 16, 2024.

(51) Int. Cl. G06F 7/544; G06F 5/08; G06F 7/523

(52) U.S. Cl. CPC G06F 7/5443; G06F 5/08; G06F 7/523

(57) ABSTRACT

A multiplexor (MUX) for a processing unit of memory is described herein. The MUX and a plurality of multiply-accumulate (MAC) units coupled to the MUX can receive a plurality of data values. The MUX can provide a first half of the plurality of data values to the plurality of MAC units during a first half of a duration of time and can provide a second half of the plurality of data values to the plurality of MAC units during a second half of the duration of time. The plurality of MAC units can perform a first plurality of multiplication operations utilizing the first half of the plurality of data values and can perform a second plurality of multiplication operations utilizing the second half of the plurality of data values.

### PRIORITY INFORMATION

This application claims the benefit of U.S. Provisional Application No. 63/672,124, filed on Jul. 16, 2024, the contents of which are incorporated herein by reference.

### TECHNICAL FIELD

The present disclosure relates generally to memory, and more particularly to a multiplexor for a processing unit of memory.

### BACKGROUND

Memory devices are typically provided as internal, semiconductor, integrated circuits in computers or other electronic devices. There are many different types of memory including volatile and non-volatile memory. Volatile memory can require power to maintain its data and includes random-access memory (RAM), dynamic random access memory (DRAM), and synchronous dynamic random access memory (SDRAM), among others. Non-volatile memory can provide persistent data by retaining stored data when not powered and can include NAND flash memory, NOR flash memory, read only memory (ROM), Electrically Erasable Programmable ROM (EEPROM), Erasable Programmable ROM (EPROM), and resistance variable memory such as phase change random access memory (PCRAM), resistive random access memory (RRAM), and magnetoresistive random access memory (MRAM), among others.

Memory is also utilized as volatile and non-volatile data storage for a wide range of electronic applications. Non-volatile memory may be used in, for example, personal computers, portable memory sticks, digital cameras, cellular telephones, portable music players such as MP3 players, movie players, and other electronic devices. Memory cells can be arranged into arrays, with the arrays being used in memory devices.

### BRIEF DESCRIPTION OF THE DRAWINGS

FIG. 1 is a block diagram of an apparatus in the form of a computing system including a memory device in accordance with a number of embodiments of the present disclosure.

FIG. 2 is a block diagram of a memory system of a plurality of banks of memory cells in accordance with a number of embodiments of the present disclosure.

FIG. 3 is a block diagram of a processing unit including a multiplexor in accordance with a number of embodiments of the present disclosure.

FIG. 4 is a block diagram of a processing unit including a multiplexor in accordance with a number of embodiments of the present disclosure.

FIG. 5 illustrates an example flow diagram of a method for implementing a multiplexor in a processing unit of memory in accordance with a number of embodiments of the present disclosure.

FIG. 6 illustrates an example machine of a computer system within which a set of instructions, for causing the machine to perform any one or more of the methodologies discussed herein, can be executed.

### DETAILED DESCRIPTION

The present disclosure includes a multiplexor for a processing unit of memory. The processing unit (PU) can include a plurality of multiply-accumulate (MAC) units and a multiplexor (MUX) that are coupled. The MUX and the plurality of MAC units can receive a plurality of data values. The MUX can provide a first half of the plurality of data values to the plurality of MAC units during a first half of a duration of time. The MUX can also provide a second half of the plurality of data values to the plurality of MAC units during a second half of the duration of time. The MAC units can perform a first plurality of multiplication operations utilizing the first half of the plurality of data values provided by the MUX during the first half of the duration of time. The MAC units can also perform a second plurality of multiplication operations utilizing the second half of the plurality of data values provided by the MUX during the second half of the duration of time.

In previous approaches, a PU may be implemented using a set quantity of MAC units. For example, the PU may traditionally be implemented using thirty-two MAC units. Each of the MAC units can include an accumulator register that stores thirty-two data values (e.g., bits). Each of the thirty-two MAC units can receive eight bits of data every time data is sensed (e.g., read) from a memory array (e.g., a bank of memory). The read latency can be 5 nanoseconds (ns). Each of the thirty-two MAC units can receive eight bits of data every 5 ns. Each of the eight bits of data can represent a different data value. Each of the thirty-two MAC units can receive a data value every time data is sensed. For example, each of the thirty-two MAC units can receive a data value every 5 ns.

However, the MAC units may perform MAC operations in less time than the read latency. For example, the MAC units may perform a plurality of operations utilizing the received eight bits of data in less time than the 5 ns read latency. As such, the MAC units, or portions of the MAC units, may be underutilized because the MAC units or portion of the MAC units remain inactive for the remaining portion of the 5 ns.

In order to address these and other deficiencies of previous approaches, embodiments of the present disclosure implement a PU that provides data (e.g., data values) to the MAC units such that the MAC units are continually utilized. Continually utilizing the MAC units allows for fewer MAC units to be utilized. As used herein, a PU can include hardware and/or firmware to perform a plurality of operations. The PU can include MAC units which include hardware and/or firmware for performing a plurality of multiplication operations and a plurality of accumulation operations referred to as MAC operations.

For example, in embodiments of the present disclosure, a MUX can be implemented in the PU that receives the data values. The MUX can provide portions of the data values in less time than the read latency. As used herein, the read latency refers to an interval of time starting when first data is sensed from the memory array and ending when second data is sensed from the array. For example, the MUX can provide a first portion and a second portion of the data values during the read latency such that the MAC units are utilized for the entirety of the read latency.

Given that the MAC units remain utilized for the read latency, fewer MAC units can be utilized than are utilized if the MAC units are only partially utilized during the read latency (e.g., as with previous approaches). For example, if thirty-two MAC units are partially utilized during a read latency (e.g., as with previous approaches), then only sixteen MAC units can be fully utilized for the same duration of time with the use of a MUX to continuously provide data to the sixteen MAC units in accordance with embodiments of the present disclosure. As used herein, a MUX can continuously provide data if the MUX provides data multiple times in a time span (e.g., duration of time). For example, a MUX can continuously provide data values during a read latency if the MUX provides both first data and second data during the read latency, where the first data and the second data are provided separately.

The PU can be used to implement an artificial neural network (ANN) using the MAC units, for example. As used herein, ANNs can provide learning by forming probability weight associations between an input and an output. The probability weight associations can be provided by a plurality of nodes that comprise the ANN. The nodes together with weights, biases, and activation functions can be used to generate an output of the ANN based on the input to the ANN. A plurality of nodes of the ANN can be grouped to form layers of the ANN.

As used herein, artificial intelligence (AI) refers to the ability to improve an apparatus through “learning” such as by storing patterns and/or examples which can be utilized to take actions at a later time. Deep learning refers to a device's ability to learn from data provided as examples. Deep learning can be a subset of AI. Neural networks, among other types of networks, can be classified as deep learning. Improving the efficiency at which ANNs are executed can improve a function of a memory device executing the ANN and the function of the device in which the memory device is implemented. For example, improving the latency, power consumption, and/or throughput of the memory device implementing the ANN can cause an improvement to the latency, power consumption, and/or throughput of a memory system.

As used herein, “a number of” something can refer to one or more of such things. For example, a number of memory devices can refer to one or more memory devices. A “plurality” of something intends two or more. Additionally, designators such as “N,” as used herein, particularly with respect to reference numerals in the drawings, indicates that a number of the particular feature so designated can be included with a number of embodiments of the present disclosure.

The figures herein follow a numbering convention in which the first digit or digits correspond to the drawing figure number and the remaining digits identify an element or component in the drawing. Similar elements or components between different figures may be identified by the use of similar digits. As will be appreciated, elements shown in the various embodiments herein can be added, exchanged, and/or eliminated so as to provide a number of additional embodiments of the present disclosure. In addition, the proportion and the relative scale of the elements provided in the figures are intended to illustrate various embodiments of the present disclosure and are not to be used in a limiting sense.

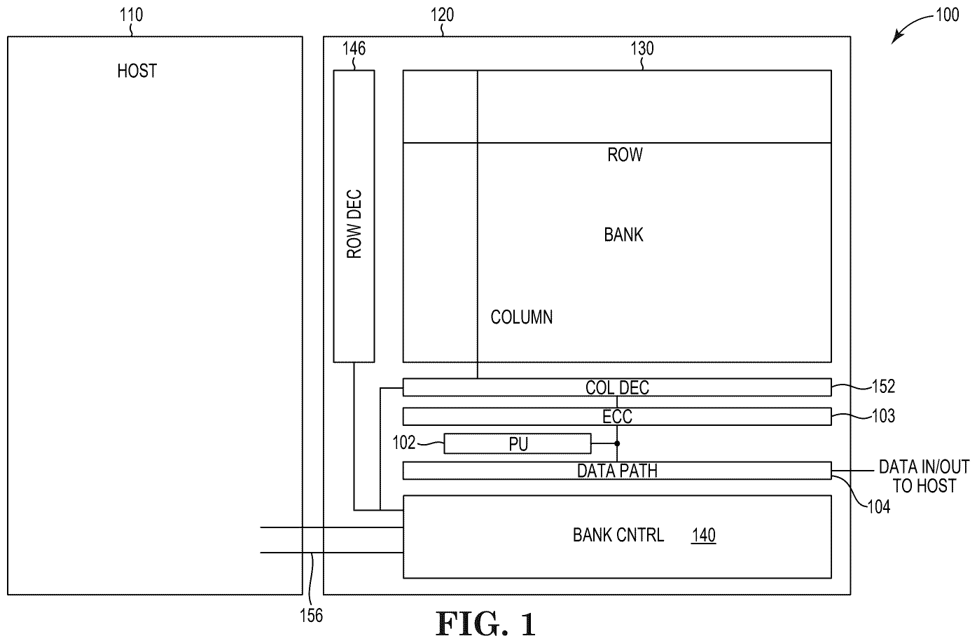

FIG. 1 is a block diagram of an apparatus in the form of a computing system 100 including a memory device 120 in accordance with a number of embodiments of the present disclosure. As used herein, a memory device 120, a bank 130 of memory cells, also referred to as a memory array 130, a host 110, and/or the PU might also be separately considered an “apparatus.”

In this example, system 100 includes a host 110 coupled to memory device 120 via an interface 156. The computing system 100 can be a personal laptop computer, a desktop computer, a digital camera, a mobile telephone, a memory card reader, or an Internet-of-Things (IoT) enabled device, among various other types of systems. Host 110 can include a number of processing resources (e.g., one or more processors, microprocessors, or some other type of controlling circuitry) capable of accessing memory 120. The system 100 can include separate integrated circuits, or both the host 110 and the memory device 120 can be on the same integrated circuit. For example, the host 110 may be a system controller of a memory system comprising multiple memory devices 120, with the system controller 110 providing access to the respective memory devices 120 by another processing resource such as a central processing unit (CPU).

In the example shown in FIG. 1, the host 110 is responsible for executing an operating system (OS) and/or various applications that can be loaded thereto (e.g., from memory device 120 via controller 140). The host 110 can provide access commands and/or security mode initialization commands to a memory device via the interface 156.

For clarity, the system 100 has been simplified to focus on features with particular relevance to the present disclosure. The memory array 130 can be a DRAM array, SRAM array, STT RAM array, PCRAM array, TRAM array, RRAM array, NAND flash array, and/or NOR flash array, for instance. The array 130 can comprise memory cells arranged in rows coupled by access lines (which may be referred to herein as word lines or select lines) and columns coupled by sense lines (which may be referred to herein as digit lines or data lines). Although a single array 130 is shown in FIG. 1, embodiments are not so limited. For instance, memory device 120 may include a number of arrays 130 (e.g., a number of banks 130 of DRAM cells).

The memory device 120 includes address circuitry to latch address signals provided over the interface 156. The interface 156 can include, for example, a physical interface employing a suitable protocol (e.g., a data bus, an address bus, and a command bus, or a combined data/address/command bus). Such protocol may be custom or proprietary, or the interface 156 may employ a standardized protocol, such as Peripheral Component Interconnect Express (PCIe), Gen-Z, CCIX, or the like. Address signals are received and decoded by a row decoder 146 and a column decoder 152 to access the memory array 130. Data can be read from memory array 130 by sensing voltage and/or current changes on the sense lines using sensing circuitry. The sensing circuitry can comprise, for example, sense amplifiers that can read and latch a page (e.g., row) of data from the memory array 130. The I/O circuitry can be used for bi-directional data communication with host 110 over the interface 156. Read/write circuitry is used to write data to the memory array 130 or read data from the memory array 130.

Controller 140 decodes signals provided by the host 110. These signals can include chip enable signals, write enable signals, and address latch signals that are used to control operations performed on the memory array 130, including data read, data write, and data erase operations. In various embodiments, the controller 140 is responsible for executing instructions from the host 110. The controller 140 can comprise a state machine, a sequencer, and/or some other type of control circuitry, which may be implemented in the form of hardware, firmware, or software, or any combination of the three.

In various instances, the controller 140 can receive signals provided by the host 110 including signals requesting operations to be performed by the PU 102. As used herein, the PU 102 can include hardware, firmware, and/or software for performing operations, such as, for example, multiplication operations, using data provided by the memory array 130 and/or the host 110.

In various examples, error correction code (ECC) circuitry 103 can be coupled to the column decoder 152. The ECC circuitry 103 can receive data from the memory array 130. The ECC circuitry 103 can perform error correction operations to correct errors in data sensed from the memory array 130. The PU 102 can be coupled to the ECC circuitry 102. The PU 102 can perform a plurality of operations on data received from the ECC circuitry 102. The PU 102 can provide an output to the data path 104. The data path 104 can provide data to the interface 156. In various instances, the data path 104 can include Input/Output (I/O lines) and/or receivers and/or drivers. As used herein, receivers can include circuitry configured to receive a signal. Drivers can describe circuitry to drive a signal across a line or a plurality of lines.

The PU 102 can include multiple MAC units. The MAC units can perform operations (e.g., multiplication operations) to implement an ANN. The PU 102 can also include a MUX that receives data values from (e.g., sensed from) memory array 130 (e.g., data that has been corrected by the ECC circuitry 102). The MUX can provide data values received at the same time continuously to the MAC units. For example, the MUX can receive a plurality of data values (e.g., represented using a quantity of bits) during a duration of time (e.g., during a time period). The MUX can provide a first portion of the data values followed by a second portion of the data values to the MAC units within the time period. Implementing a MUX in a PU to provide data to the MAC units allows for less MAC units to be utilized than implementing the PU without a MUX. Although the implementations described herein utilize a MUX, the examples described herein can be extended to include different circuitry that can receive data, divide the data, and provide the divided data continuously over a period of time. For example, registers can be utilized instead of a MUX to perform the functions of a MUX. Although the examples provided herein are given in the context of data values, the examples described herein can be extended to include bits. For example, the MUX can provide a first portion and a second portion of a plurality of bits that represent data values to MAC units during a time period.

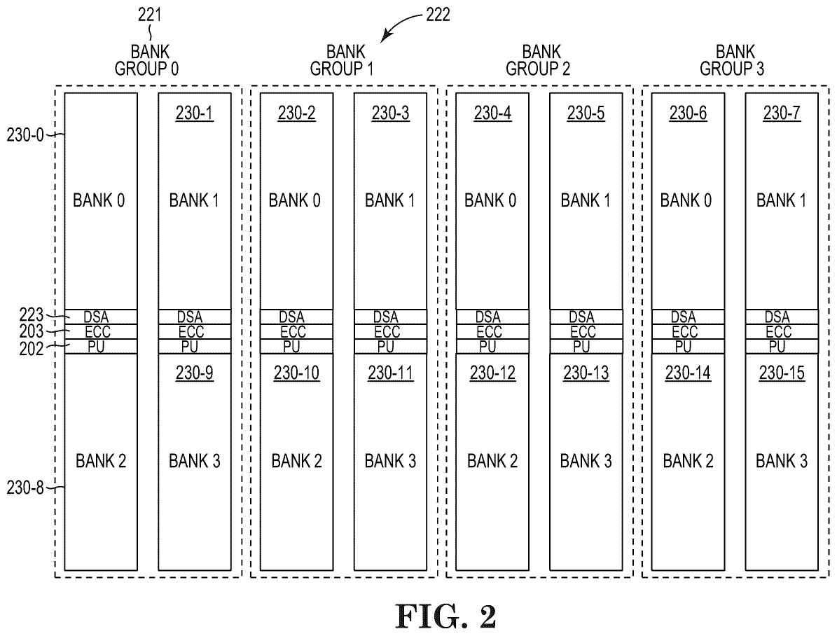

FIG. 2 is a block diagram of a memory system 222 having a plurality of banks of memory cells in accordance with a number of embodiments of the present disclosure. The banks 230-0, 230-1, 230-2, 230-3, 230-4, 230-5, 230-6, 230-7, 230-8, 230-9, 230-10, 230-11, 230-12, 230-13, 230-14, 230-15 can be referred to collectively as banks 230. The banks 230 can be analogous to bank 130 previously described in connection with FIG. 1. Further, although 16 banks are shown in the example illustrated in FIG. 2, embodiments of the present disclosure are not limited to a particular number of banks.

The banks 230 can be grouped into bank groups 221. For example, the banks 230-0, 230-1, 230-8, 230-9 can be grouped into a first bank group (e.g., bank group 0). The banks 230-2, 230-3, 230-10, 230-11 can be grouped into a second bank group (e.g., bank group 1). The banks 230-4, 230-5, 230-12, 230-13 can be grouped into a third bank group (e.g., bank group 2). The banks 230-6, 230-7, 230-14, 230-15 can be grouped into a fourth bank group (e.g., bank group 3).

The banks of each respective bank group can be organized into pairs that share at least a PU 202. For example, the banks 230-0, 230-8 of bank group 0 share a first PU (e.g., the PU 202). The banks 230-1, 230-9 of bank group 0 share a second PU. The banks 230-2, 230-10 of bank group 1 share a third PU. The banks 230-3, 230-11 of bank groupb 1 share a fourth PU. The banks 230-4, 230-12 of bank group 2 share a fifth PU. The banks 230-5, 230-13 of bank group 2 share a sixth PU. The banks 230-6, 230-14 of bank group 3 share a seventh PU. The banks 230-7, 230-15 of bank group 3 share an eighth PU. The example of FIG. 2 also shows the bank pairs sharing data sense amplifiers (e.g., DSA) 223 and error correction circuitry 203 in an analogous manner. In various examples, each bank can have its own DSA 223 and ECC circuitry 203 but may share the PU 202. Having separate DSAs 223 and ECC circuitries 203 allows each of the banks 230 to provide data to the shared PU 202 independent of the other banks. For example, if a read latency of the banks 230 is 5 ns, then a first bank 230-0 can provide data to the PU 202 at the start of the 5 ns and a second bank 230-8 can provide data to the PU 202 halfway through the 5 ns (e.g., 2.5 ns).

Each of the PUs 202 can include a MUX. The MUX enables the PU 202 to be implemented with less MAC units while retaining the same throughput. For example, if each of the PUs 202 is implemented with sixteen MAC units instead of thirty-two MAC units, then the PUs 202 can be implemented with sixty-four MAC units using the MUXs instead of one hundred twenty-eight MAC units. The MUXs allows for the PUs 202 to be implemented with at least half the MAC units than PUs implemented without the MUXs. If 4:1 MUXs are utilized in the PUs 202, the PUs 202 can be implemented with eight MAC units instead of one hundred twenty-eight MAC units used to implement PUs 202 without MUXs.

Implementing the PUs 202 using fewer MAC units can decrease the cost of implementing the PUs 202. Implementing the PUs 202 using fewer MAC units can also decrease the size of the die that includes the PUs 202.

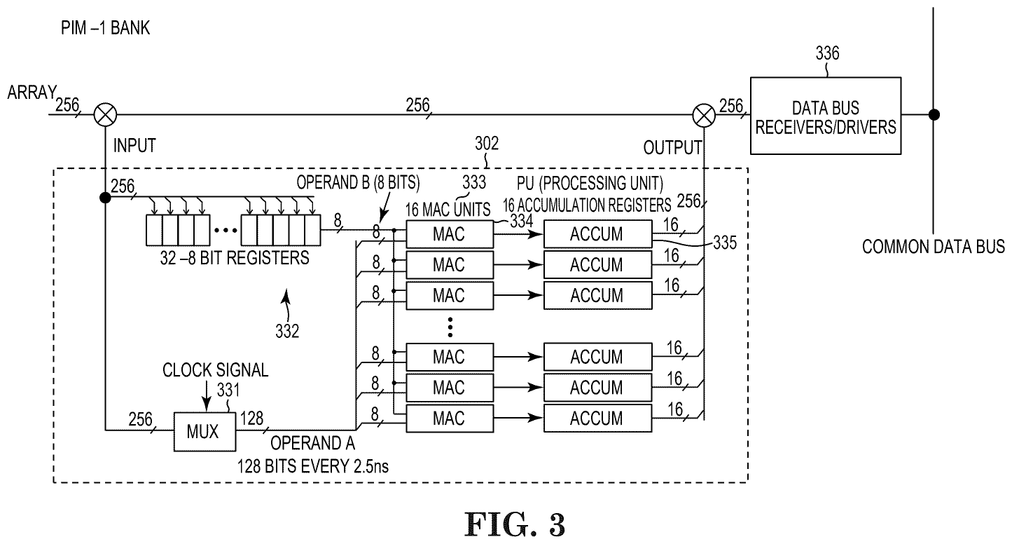

FIG. 3 is a block diagram of a processing unit 302 (e.g., PU 102 of FIG. 1 and/or PU 202 of FIG. 2) including a MUX 331 (e.g., a 2:1 MUX) in accordance with a number of embodiments of the present disclosure. The PU 302 can include the MUX 331 (e.g., 2:1 MUX), a shift register 332, and MAC units 333. The PU 302 can receive data from banks (e.g., memory array), as previously described herein. The PU 302 can also receive data from the data bus 336. The data bus 336 can include receivers and/or drivers. The data bus 336 can couple the PU 302 to the interface of the memory system (e.g., via a common data bus). The data bus 336 can be used to provide data to the PU 302 from a host coupled to the memory system and/or from the banks of the memory system.

In the example of FIG. 3 the PU 302 can receive data from the banks and/or from the host via the data bus 336 once a read latency period. For example, a bank can provide data to the PU 302 once every 5 ns. Although the read latency is described as being 5 ns, other latencies can be utilized to describe a duration of time used to provide data to the PU 302. For example, data can be provided to the PU 302 every 10 ns or 2.5 ns.

An operand B can be provided to the PU 302 and stored in the registers 332. Operand B can comprise two hundred fifty-six bits, which can represent, for example, thirty-two data values. The thirty-two data values can be stored in the registers 332. For example, the shift registers 332 can include thirty-two eight bit registers. Each of the registers of the registers 332 can store eight bits (e.g., a data value). The operand B can be provided from a bank (e.g., DRAM array) of the memory system.

The registers 332 can be shift registers 332. The shift registers 332 can provide the same data value (e.g., eight bits) to each of the MAC units 333. Once a data value (e.g., eight bits) has been provided to the MAC units 333, the shift registers 332 can shift a position of the data values such that the next data value (e.g., the next eight bits) is available and the data value previously provided is last in line. The shift registers 332 can then provide the next data value to each of the MAC units 333. In such a fashion, the shift registers 332 can rotate through the thirty-two data values (e.g., rotate through the two hundred fifty-six bits), providing one data value (e.g., eight bits) at a time to the MAC units. 333.

The operand A can be provided from the I/O lines via the data bus 336. The operand A can also comprise thirty-two data values (e.g., two hundred fifty-six bits) that can remain active in the data bus 336 for the duration of the 5 ns. Although the examples described herein are provided in terms of data being provided in two hundred fifty-six bit chunks, other data size chunks can be provided to the PU 302. For example, the data bus 336 can carry sixteen data values (e.g., one hundred twenty-eight bits) or sixty-four data values (e.g., five hundred twelve bits).

The operand A can be provided to the MUX 331. The MUX 331 can be implemented internal to the PU 302 and between the MAC units 333 and the data bus 336. The MUX 331 can be implemented as an interface to the PU 302.

The MUX 331 can be a 2:1 MUX that provides a first half of the data values during a first half of the read latency and provides the second half of the data values during a second half of the read latency. For example, the MUX 331 can provide the first sixteen data values (e.g., one hundred twenty-eight bits) to the MAC units 333 during the first 2.5 ns of the read latency. The MUX 331 can provide the second sixteen data values (e.g., one hundred twenty-eight bits) to the MAC units during the second 2.5 ns of the read latency. The MUX 331 can receive a clock signal that enables the MUX 331 to provide data based on the partitioned read latency (e.g., every 2.5 ns). The term partitioned read latency can reference that the read latency is divided to describe different intervals than those conveyed by the read latency.

The MUX 331 can provide different data values to each of the MAC units 333. For example, given that there are sixteen MAC units 333 in the example of FIG. 3, the MUX 331 can provide sixteen data values (e.g., one hundred twenty-eight bits) to the MAC units 333 such that each of the MAC units 333 receives a different data value (e.g., eight bits) from the sixteen data values.

Each MAC unit 333 can include a multiplicator 334 and an accumulator 335 (also referred to as accumulation registers 335). Each of the MAC units 333 can receive a data value from the operand B and a data value from the operand A. The multiplicator 334 of each respective MAC unit 333 can perform a plurality of multiplication operations utilizing the received data values from the operand B and the operand A. The output of each respective multiplicator 334 can be provided to a different respective accumulator 335. Each accumulator 335 can sum the respective output of the multiplicators 334 and the previous outputs of the multiplicators 334. Each of the accumulators 335 can include thirty two-bit registers.

The example of FIG. 3 shows sixteen multiplicators 334 and sixteen accumulators 335. Reducing the quantity of the MAC units 333 can also reduce the quantity of multiplicators 334 and the quantity of accumulators 335 implemented in the PU 302. Reducing the quantity of multiplicators 334 and the quantity of accumulators 335 can reduce the size and/or cost of the PU 302.

The data in the accumulators 335 can be read to obtain the output of the MAC units 333. The interface between the accumulators 335 and the data bus 336 can also be updated to accommodate the fewer MAC units 333 implemented in view of the implementation of the MUX 331 in the PU 302. For example, each of the accumulators 335 can output two data values (e.g., sixteen bits) at time. Given that there are sixteen accumulators 335, the output of the PU 302 can be thirty-two data values (e.g., two hundred and twenty-six bits). Each of the accumulators 335 can be coupled to the data bus 336 via sixteen lines. In contrast, in previous approaches in which thirty-two accumulators were implemented, each of the accumulators 335 would be coupled to the data bus 336 using eight lines.

The implementation of the MUX 331 allows for fewer MAC units 333 to be implemented which increases the quantity of lines coupling the MAC units 333 to the data bus 336. The increase in the quantity of lines coupling the MAC units 333 to the data bus 336 allows for the same throughput to be established between the data bus 336 and the MAC units 333 as compared to implementations where the MUX 331 is not implemented.

Once the MAC units 333 conclude performing a plurality of operations on the sixteen data values (e.g. one hundred twenty-eight bits) provided by the MUX 331, the MUX 331 can provide the second sixteen data values (e.g., the second one hundred twenty-eight bits) to the MAC units 333, and operations (e.g., multiplication operations) can be performed on the second sixteen data values in ana analogous manner. The MAC units 333 can consistently be utilized in the read latency (e.g., 5 ns) because sixteen data values (e.g., one hundred twenty-eight bits) are provided to the MAC units 333 every 2.5 ns.

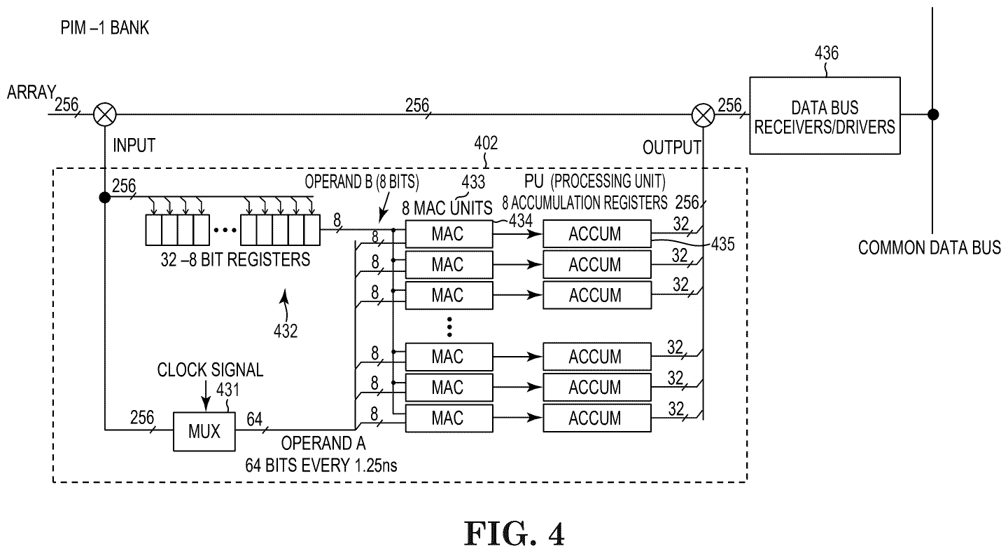

FIG. 4 is a block diagram of a processing unit including a 4:1MUX 431 in accordance with a number of embodiments of the present disclosure. The PU 402 can include the MUX 331 (e.g., 4:1 MUX), shift register 432, and MAC units 433. The PU 402 can receive data from the banks (e.g., memory array). The PU 402 can also receive data from the data bus 436. The data bus 436 can include receivers and/or drivers. The data bus 436 can couple the PU 402 to the interface of the memory system. The data bus 436 can be used to provide data to the PU 402 from the host coupled to the memory system and/or from the banks of the memory system.

In the example of FIG. 4 the PU 402 can receive data from the banks and/or from the host via the data bus 436 once every read latency. For example, a bank can provide data to the PU 402 once every 5 ns.

An operand B can be provided to the PU 402 and stored in the registers 432. Operand B can be composed of thirty-two data values. The thirty-two data values can be stored in the registers 432. For example, the shift registers 432 can include thirty-two eight bit registers. Each of the registers of the registers 432 can store a data value (e.g., eight bits). The operand B can be provided from a bank (e.g., DRAM array) of the memory system.

The registers 432 can be shift registers 432. The shift registers 432 can provide the same data value to each of the MAC units 433. Once a data value has been provided to the MAC units 433, the shift registers 432 can shift a position of the data values such that the next data value is available and the data value previously provided is last in line. The shift registers 432 can then provide the next eight bits to each of the MAC units 433. In such a fashion, the shift registers 432 can rotate through thirty-two data values, providing a data value at a time to the MAC units. 433.

The operand A can be provided from the I/O lines via the data bus 436. In examples where multiple banks are coupled to the PU 402, the operand A can be provided to the PU 402 from a first bank and operand B can be provided to the PU 402 from a second bank. For example, each of the banks can provide data to the PU 402 once every read latency. However, the banks can be staggered in providing data to the PU 402 such that the PU 402 receives data every 2.5 ns.

The operand A can also comprise thirty-two data values that can remain active in the data bus 436 for the duration of the read latency. The read latency can be 5 ns if the operand A is being received from the host or a bank. The read latency can be 2.5 ns if the operand A is being received from a bank and the operand B is received from a different bank.

Although the examples described herein are provided in terms of data being provided in two hundred fifty-six chunks (e.g., providing thirty-two data values), other size chunks can be provided to the PU 402. For example, the data bus 436 can carry sixteen data values (e.g., one hundred twenty-eight bits) or sixty-four data values (e.g., five hundred twelve bits).

The operand A can be provided to the MUX 431. The MUX 431 can be implemented internal to the PU 402 and between the MAC units 433 and the data bus 436. The MUX 431 can be implemented as an interface to the PU 402.

The MUX 431 can be a 4:1 MUX that provides a first portion of the data values during a first portion the read latency, a second portion of the data values during a second portion of the read latency, a third portion of the data values during a third portion of the read latency, and a fourth portion of the data values during a fourth portion of the read latency. The data values can include the data values of the operand A. For example, the MUX 431 can provide the first eight data values (e.g., the first sixty-four bits) to the MAC units 433 during the first 1.25 ns of the read latency. The MUX 431 can provide the second eight data values (e.g., the second sixty-four bits) to the MAC units during the second 1.25 ns of the read latency. The MUX 431 can provide the third eight data values (e.g., the third sixty-four bits) to the MAC units during the third 1.25 ns of the read latency. The MUX 431 can provide the fourth data values (e.g., the fourth sixty-four bits) to the MAC units during the fourth 1.25 ns of the read latency. The MUX 431 can receive a clock signal that enables the MUX 431 to provide data values based on the partitioned read latency (e.g., every 1.25 ns).

The MUX 431 can provide a different data value to teach of the MAC units 433. For example, given that there are eight MAC units 433 in the example of FIG. 4, the MUX 431 can provide eight data values (e.g., sixty-four bits) to the MAC units 433, at the same time, such that each of the MAC units 433 receives a different data value from the eight data values.

The MAC units 433 can include a multiplicator 434 and an accumulator 435 also referred to as accumulation registers 435. Each of the MAC units 433 can receive a data value from the operand B and a different data value from the operand A. The multiplicators 434 can perform a plurality of multiplication operations using the data values from the operand B and the operand A. The output of the multiplicators 434 can be provided to the accumulators 435. The accumulators 435 can sum the output of the multiplicators 434 and the previous outputs of the multiplicators 334. The accumulators 335 can each include thirty two-bit registers. The example of FIG. 4 shows eight multiplicators 434 and eight accumulators 435. Reducing the quantity of the MAC units 433 can also reduce the quantity of multiplicators 434 and the quantity of accumulators 435 implemented in the PU 402. Reducing the quantity of multiplicators 434 and the quantity of accumulators 435 can reduce the expense of implementing the PU 402.

The accumulators 435 can be read to obtain the output of the MAC units 433. The interface between the accumulators 435 and the data bus 436 can also be updated to accommodate that fewer MAC units 433 are implemented in view of the implementation of the MUX 431 (e.g., 4:1 MUX) in the PU 402. For example, each of the accumulators 435 can output thirty-two bits at time. Given that there are eight accumulators 435, the output of the PU 402 can be two hundred and twenty-six bits. Each of the accumulators 435 can be coupled to the data bus 436 via thirty-two lines. In previous approaches where thirty-two accumulators were implemented each of the accumulators 435 are coupled to the data bus 436 using eight bits.

The implementation of the MUX 431 allows for fewer MAC units 433 to be implemented which increases the quantity of lines coupling the MAC units 4533 to the data bus 436 to retain the same throughput of two hundred fifty-six bits. The increase in the quantity of lines coupling the MAC units 433 to the data bus 436 allows for a same throughput to be established between the data bus 436 and the MAC units 433 as compared to implementations where the MUX 431 is not implemented.

Once the MAC units 433 conclude performing a plurality of operations on the eight data values provided by the MUX 431, the MUX 431 can provide the second eight data values to the MAC units 433, etc. The MAC units 433 can consistently be utilized in the read latency (e.g., 5 ns) because eight data values are provided to the MAC units 433 every 1.25 ns.

In various examples, the operand A can be provided from a first bank and a second bank coupled to the PU 402. Given that the read latency of the first bank is 5 ns and that the read latency of the second bank is also 5 ns. The first bank and the second bank can be configured to provide data at staggered intervals. For example, the first bank can provide data in the first 2.5 ns while the second bank provides data in the second 2.5 ns.

The MUX internal to the bank 402 can be configured as a 2:1 MUX. The MUX can receive the first operand A from the first bank and can provide a first half of the data during the first 1.25 ns of the read latency. The MUX can provide the second half of the first operand A in the second 1.25 ns. The MUX can receive a second operand A from a different bank and can provide a first half of the second operand A during the third 1.25 ns of the read latency. The MUX can provide the second half of the second operand A during the fourth 1.25 ns of the read latency. The sixteen MAC units can receive the operand A and the operand B from the MUX as similarly shown in FIG. 3.

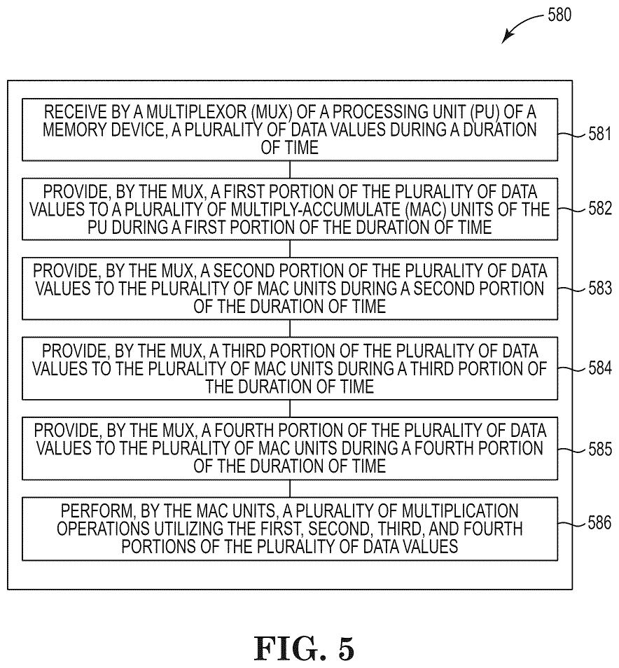

FIG. 5 illustrates an example flow diagram of a method 580 for implementing (e.g., operating) a multiplexor in a processing unit of memory in accordance with a number of embodiments of the present disclosure. The method can be performed by a memory device of a computing system, such as, for instance, memory device 120 of computing system 100 previously described in connection with FIG. 1.

At 581, a MUX of a PU of the memory device can receive a plurality of data values. The MUX can receive the plurality of data values during a duration of time. The duration of time can be 5 ns for example. At 582, a plurality of MAC units can receive the plurality of data values. At 582, The MUX can provide a first portion of the plurality of data values to the MAC units of the PU during a first portion of a duration of time. The first portion of the plurality of data values can be a first quarter of the plurality of data values. The first portion of the duration of time can be a first quarter of the duration of time. At 583, the MUX can provide a second portion of the plurality of data values to the MAC units during a second portion of the duration of time. The second portion of the plurality of data values can be a second quarter of the plurality of data values. The second portion of the duration of time can be a second quarter of the duration of time. The data values can be an operand used to perform MAC operations using the MAC units of the PU.

At 584, the MUX can provide a third portion of the plurality of data values to the MAC units during a third portion of the duration of time. The third portion of the plurality of data values can be a third quarter of the plurality of data values. The third portion of the duration of time can be a third quarter of the duration of time. At 585, the MUX can provide a fourth portion of the plurality of data values to the MAC units during a fourth portion of the duration of time. The fourth portion of the plurality of data values can be a fourth quarter of the plurality of data values. The fourth portion of the duration of time can be a fourth quarter of the duration of time. At 586, the MAC units can perform a plurality of multiplication operations utilizing the first, second, third, and fourth portions of the plurality of data values.

The MAC units can perform the plurality of multiplication operations utilizing the portions (e.g., the first quarter, the second quarter, the third quarter, and the fourth quarter) of the plurality of data values. The MAC units can perform a first plurality of multiplication operations utilizing the first portion (e.g., first quarter) of the plurality of data values, a second plurality of multiplication operations utilizing the second portion (e.g., second quarter) of the plurality of data values, a third plurality of multiplication operations utilizing the third portion (e.g., third quarter) of the plurality of data values, and a fourth plurality of multiplication operations utilizing the fourth portion (e.g., fourth quarter) of the plurality of data values. Each of the first portion of the plurality of data values, the second portion of the plurality of data values, the third portion of the plurality of data values, and the fourth portion of the plurality of data values can include a same quantity of data values. For example, each of the portions can include eight data values (e.g., sixty-four bits). In examples, where only two portions are provided to the MAC units, each of the two portions can include sixteen data values (e.g., one hundred twenty-eight bits).

In various examples, the PU can be configured to function in multiple modes. Each of the modes can represent a configuration of the MUX internal to the PU. For example, the MUX can be configured to function in a 2:1 configuration or a 4:1 configuration. A first mode can represent a 2:1 configuration of the MUX while a second mode represents a 4:1 configuration of the MUX. Although the examples described herein are given in the context of a 2:1 MUX or a 4:1 MUX, other types of MUXs can be utilized and corresponding modes of the PU can be implemented. For example, an 8:1 MUX can be implemented in a PU, among other types of MUXs that can be implemented in the PU.

Although multiple modes of the PU are contemplated to configure a MUX, a single mode MUX can be implemented. For example, a 4:1 MUX can be implemented in a PU. The first mode of the PU can be used to configure the 4:1 MUX to function in a 2:1 capacity. The second mode of the PU can be used to configure the 4:1 MUX to function in a 4:1 capacity.

A controller can be used to determine whether the PU is in a first mode or a second mode. Responsive to determining that the PU is in the first mode, the MUX of the PU can be configured to function as a 4:1 MUX. The MUX configured as a 4:1 MUX can provide the first portion, the second portion, the third portion, and the fourth portion of the plurality of data values to the plurality of MAC units.

Responsive to determining that the PU is in a second mode, the MUX can be configured to function as a 2:1 MUX. The MUX configured as a 2:1 MUX can provide a first portion of an additional plurality of data values to a first portion of the plurality of MAC units during the first portion of the duration of time. The MUX configured as a 2:1 MUX can also provide a second portion of the additional plurality of data values to the first portion of the plurality of MAC units during the second portion of the duration of time. The mode of the PU can also be used to configure a control signal provided to the MUX that enables the MUX to provide data in 5 ns, 2.5 ns, and/or 1.25 ns intervals.

The MUX and the plurality of MAC units can be coupled such that the MUX provides data values to a first portion of the plurality of MAC units and not a second portion of the plurality of MAC units if the MUX is configured as a 4:1 MUX. The MUX and the plurality of MAC units can be coupled such that the MUX provides data values to a first portion and a second portion of the plurality of MAC units if the MUX is configured as a 2:1 MUX.

For example, the MUX, if configured as a 4:1 MUX can provide the first portion, the second portion, the third portion, and the fourth portion of the plurality of data values includes providing the first portion, the second portion, the third portion, and the fourth portion to a first portion of the MAC units and not a second portion of the MAC units. For example, if sixteen MAC units are implemented in a PU to support a 2:1 MUX but the MUX is configured as a 4:1, then the MUX can provide the operand A to eight of the MAC units (e.g., a first portion of the MAC units). If the MUX is configured as a 2:1 MUX, the MUX can provide the operand A to sixteen of the MAC units (e.g., the first portion and the second portion of the MAC units).

The plurality of data values can be received at the MUX from I/O lines of the memory device. For example, the plurality of data values can be received from externally to the memory device via the I/O lines. The plurality of data values (e.g., the operand A) can be received from a host coupled to the memory device via the I/O lines.

In various examples, a PU can be implemented to include a MUX configured to receive a plurality of data values. A plurality of MAC units of the PU can be coupled to the MUX. The plurality of MAC units can receive a plurality of data values.

The MUX can receive the plurality of data values which can be the operand A, for example. The MUX can be a 2:1 MUX. The MUX can provide a first half of the plurality of data values to the plurality of MAC units during a first half of a duration of time. The MUX can provide a second half of the plurality of data values to the plurality of MAC units during a second half of the duration of time.

The MAC units can perform a first plurality of multiplication operations utilizing the first half of the plurality of data values during the first half of the duration of time. The MAC units can perform a second plurality of multiplication operations utilizing the second half of the plurality of data values during the second half of the duration of time. The MAC units can also perform a plurality of accumulation operations utilizing the output of the multiplication operations. The MAC units can provide an output to the accumulation operations consistent with the size of the data bus. For example, the MAC units can provide thirty-two bits each to the data bus 436. The output of the MAC units can be provided to a host and/or stored back to the banks.

The MUX can receive an additional plurality of data values after the duration of time. The different plurality of data values can be a second operand A received after the first operand A. The first operand A can be received in the first 5 ns. The second operand A can be received in a second 5 ns. The MUX can continuously receive different operand As every read latency. For example, the MUX can receive a new operand A every 5 ns.

The MUX can provide each of the plurality of MAC units additional data values of the first half of the plurality of data values. For example, the MUX can provide each of the MAC units a different data value from the first half of the plurality of data values. If the data (e.g., operand A) includes thirty-two data values, then each of the halves, including the first half, of the plurality of data can include sixteen data values.

The MAC units can receive a same quantity of data values in the first half of the duration of time and the second half of the duration of time. For example, each of the MAC units can receive a data value in the first half of the duration of time and an additional data value in the second half of the duration of time.

The MUX can receive an additional plurality of data values. The additional plurality of data values can be a different operand A. The MUX can provide the additional plurality of data values to the plurality of MAC units and to an additional plurality of MAC units during an additional duration of time. For example, if the MUX can be configured to function in a 1:1 capacity or a 2:1 capacity, then the MUX can be configured to function in a 1:1 capacity after previously being configured in a 2:1 capacity. In a 1:1: capacity, the MUX can provide data to twice as many MAC units as the MUX is configured to provide data to in the 2:1 capacity. If the MUX configured in a 2:1 capacity provide data to sixteen MAC units, the MUX configured in a 1:1 capacity can provide data to thirty-two MAC units. The quantity of the plurality of MAC units can be equal to the quantity of the additional plurality of MAC units. For instance, if the plurality of MAC units includes sixteen MAC units, then the additional plurality of MAC units can also include sixteen MAC units.

Responsive to performing the plurality of multiplication operations utilizing the first half of the plurality of data values provided by the MUX and responsive to performing the second plurality of multiplication operations utilizing the second half of the plurality of data values provided by the MUX, the MAC units can provide the plurality of output data values to a data bus. Each respective one of the plurality of MAC units can provide a first quantity of the plurality of output data values. For example, each of the MAC units can provide sixteen output bits to the data bus over a number of iterations to provide all of the bits stored in accumulators of the MAC units.

Responsive to performing an additional plurality of multiplication operations utilizing the additional plurality of data values, the MAC units and the additional MAC units can provide an additional plurality of output data values to the data bus. For example, each of the MAC units and the additional MAC units can provide a data value (e.g., eight bits) to the data bus. Each of the MAC units can provide a second quantity of the different plurality of output data values. The first quantity of the plurality of output data values can be two data values. The second quantity of the plurality of the plurality of output data values can be four data values (e.g., thirty-two output bits).

In various examples, the first quantity of the plurality of output data values is not equal to the second quantity of the additional plurality of output data values. For instance, the first quantity can be equal to two data values while the second quantity can be equal to four data values. The first quantity of the plurality of output data values can be half of the second quantity of the additional plurality of output data values (e.g., sixteen is half of thirty-two).

In various instances, a PU can include a shift register configured to receive a plurality of data values. The PU can also include a MUX configured to receive the plurality of data values. The PU can further include a plurality of MAC units coupled to the shift register and the MUX. The MAC units can receive a first plurality of data values from the shift register.

The MUX can provide a second portion of the plurality of data values to the plurality of MAC units during a first portion of a duration of time. The MUX can provide a third plurality of data values to the plurality of MAC units during a second portion of the duration of time. The plurality of MAC units can perform a first plurality of multiplication operations utilizing the first portion of the plurality of data values and the second portion of the plurality of data values. The plurality of MAC units can perform a second plurality of multiplication operations utilizing the first portion of the plurality of data values and the third portion of the plurality of data values. The memory device can include a first bank and a second bank. The MUX can receive the second portion of the plurality of data values from the first bank. The MUX can receive a third portion of the plurality of data values from the second bank.

The MUX can receive the first portion of the plurality of data values in the first portion of the duration of time. The MUX can also receive the second portion of the plurality of data values in the second portion of the duration of time.

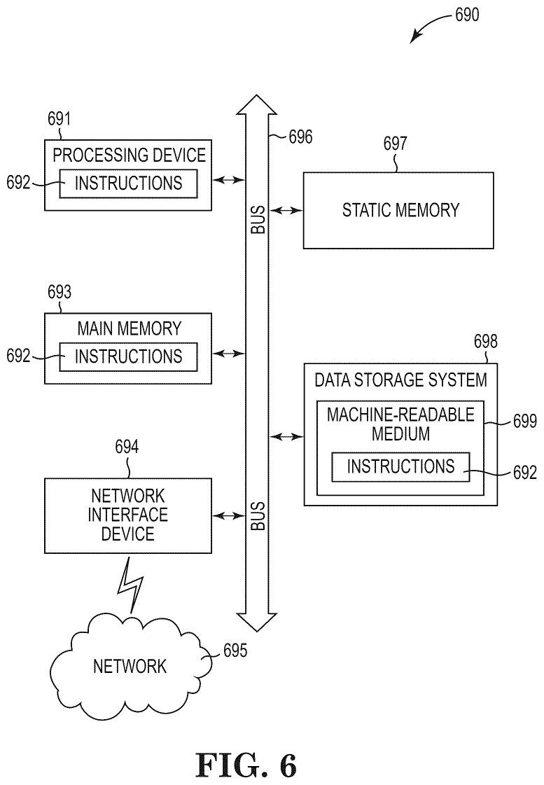

FIG. 6 illustrates an example machine of a computer system 690 within which a set of instructions, for causing the machine to perform any one or more of the methodologies discussed herein, can be executed. In some embodiments, the computer system 690 can correspond to a host system (e.g., the host 110 of FIG. 1) that includes, is coupled to, or utilizes a memory system (e.g., the memory system 120 of FIG. 1) or can be used to perform the operations of the PU (e.g., the PU 102 of FIG. 1). In alternative embodiments, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 690 includes a processing device 691, a main memory 693 (e.g., read-only memory (ROM), flash memory, dynamic random access memory (DRAM) such as synchronous DRAM (SDRAM) or Rambus DRAM (RDRAM), etc.), a static memory 697 (e.g., flash memory, static random access memory (SRAM), etc.), and a data storage system 698, which communicate with each other via a bus 696.

Processing device 691 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 691 can also be one or more special-purpose processing devices such as an application specific integrated circuit (ASIC), a field programmable gate array (FPGA), a digital signal processor (DSP), network processor, or the like. The processing device 691 is configured to execute instructions 692 for performing the operations and steps discussed herein. The computer system 690 can further include a network interface device 694 to communicate over the network 695.

The data storage system 698 can include a machine-readable storage medium 699 (also known as a computer-readable medium) on which is stored one or more sets of instructions 692 or software embodying any one or more of the methodologies or functions described herein. The instructions 692 can also reside, completely or at least partially, within the main memory 693 and/or within the processing device 691 during execution thereof by the computer system 690, the main memory 693 and the processing device 691 also constituting machine-readable storage media.

In one embodiment, the instructions 692 include instructions to implement functionality corresponding to the PU 102 of FIG. 1. While the machine-readable storage medium 699 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Although specific embodiments have been illustrated and described herein, those of ordinary skill in the art will appreciate that an arrangement calculated to achieve the same results can be substituted for the specific embodiments shown. This disclosure is intended to cover adaptations or variations of various embodiments of the present disclosure. It is to be understood that the above description has been made in an illustrative fashion, and not a restrictive one. Combinations of the above embodiments, and other embodiments not specifically described herein will be apparent to those of skill in the art upon reviewing the above description. The scope of the various embodiments of the present disclosure includes other applications in which the above structures and methods are used. Therefore, the scope of various embodiments of the present disclosure should be determined with reference to the appended claims, along with the full range of equivalents to which such claims are entitled.

In the foregoing Detailed Description, various features are grouped together in a single embodiment for the purpose of streamlining the disclosure. This method of disclosure is not to be interpreted as reflecting an intention that the disclosed embodiments of the present disclosure have to use more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. An apparatus, comprising:
a multiplexor (MUX) configured to receive a plurality of data values; and
a plurality of multiply-accumulate (MAC) units coupled to the MUX and configured to receive the plurality of data values;
wherein the MUX is configured to:
provide a first half of the plurality of data values to the plurality of MAC units during a first half of a duration of time; and
provide a second half of the plurality of data values to the plurality of MAC units during a second half of the duration of time; and
wherein the plurality of MAC units are configured to:
perform a first plurality of multiplication operations utilizing the first half of the plurality of data values provided by the MUX during the first half of the duration of time; and
perform a second plurality of multiplication operations utilizing the second half of the plurality of data values provided by the MUX during the second half of the duration of time.

2. The apparatus of claim 1, wherein the MUX is further configured to provide different data values of the first half of the plurality of data values to each respective one of the plurality of MAC units.

3. The apparatus of claim 1, wherein the MUX is further configured to provide a same quantity of data values to each respective one of the plurality of MAC units during the first half of the duration of time and the second half of the duration of time.

4. The apparatus of claim 1, wherein the MUX is configured to:
receive an additional plurality of data values; and
provide the additional plurality of data values to the plurality of MAC units and to an additional plurality of MAC units during an additional duration of time.

5. The apparatus of claim 4, wherein a quantity of the plurality of MAC units is equal to a quantity of the additional plurality of MAC units.

6. The apparatus of claim 4, wherein the plurality of MAC units are further configured to:
responsive to performing the first plurality of multiplication operations utilizing the first half of the plurality of data values provided by the MUX and performing the second plurality of multiplication operations utilizing the second half of the plurality of data values provided by the MUX, provide a plurality of output data values to a data bus;
wherein each respective one of the plurality of MAC units provides a first quantity of the plurality of output data values.

7. The apparatus of claim 6, wherein the plurality of MAC units are further configured to:
perform an additional plurality of multiplication operations utilizing the additional plurality of data values; and
provide an additional plurality of output data values to the data bus; and
wherein each respective one of the plurality of MAC units provides a second quantity of the additional plurality of output data values.

8. The apparatus of claim 7, wherein the first quantity of the plurality of output data values is not equal to the second quantity of the additional plurality of output data values.

9. The apparatus of claim 7, wherein the first quantity of the plurality of output data values is half of the second quantity of the additional plurality of output data values.

10. The apparatus of claim 1, wherein the MUX is further configured to receive an additional plurality of data values after the duration of time.

11. A method, comprising:
receiving, by a multiplexor (MUX) of a processing unit (PU) of a memory device, a plurality of data values during a duration of time;
providing, by the MUX, a first portion of the plurality of data values to a plurality of multiply-accumulate (MAC) units of the PU during a first portion of the duration of time;
providing, by the MUX, a second portion of the plurality of data values to the plurality of MAC units during a second portion of the duration of time;
providing, by the MUX, a third portion of the plurality of data values to the plurality of MAC units during a third portion of the duration of time;
providing, by the MUX, a fourth portion of the plurality of data values to the plurality of MAC units during a fourth portion of the duration of time; and
performing, by the MAC units, a plurality of multiplication operations utilizing the first, second, third, and fourth portions of the plurality of data values.

12. The method of claim 11, wherein performing the plurality of multiplication operations includes:
performing a first plurality of multiplication operations utilizing the first portion of the plurality of data values;
performing a second plurality of multiplication operations utilizing the second portion of the plurality of data values;
performing a third plurality of multiplication operations utilizing the third portion of the plurality of data values; and
performing a fourth plurality of multiplication operations utilizing the fourth portion of the plurality of data values.

13. The method of claim 11, wherein each of the first portion of the plurality of data values, the second portion of the plurality of data values, the third portion of the plurality of data values, and the fourth portion of the plurality of data values includes a same quantity of data values.

14. The method of claim 11, further comprising:
determining whether the PU is in a first mode or a second mode;
responsive to determining that the PU is in the first mode, providing the first portion, the second portion, the third portion, and the fourth portion of the plurality of data values to the plurality of MAC units; and
responsive to determining that the PU is in the second mode:
providing, by the MUX, a first portion of an additional plurality of data values to a first portion of the plurality of MAC units during the first portion of the duration of time; and
providing, by the MUX, a second portion of the additional plurality of data values to the first portion of the plurality of MAC units during the second portion of the duration of time.

15. The method of claim 11, wherein the method includes providing the first portion of the plurality of data values, the second portion of the plurality of data values, the third portion of the plurality of data values, and the fourth portion of the plurality of data values to a first portion of the plurality of MAC units and not to a second portion of the plurality of MAC units.

16. The method of claim 11, wherein the method includes receiving, by the MUX, the plurality of data values from input/output (I/O) lines of the memory device.

17. The method of claim 11, wherein the method includes receiving, by the MUX, the plurality of data values from a host coupled to the memory device.

18. An apparatus, comprising:
a shift register configured to receive a first plurality of data values;
a multiplexor (MUX) configured to receive a second plurality of data values and a third plurality of data values; and
a plurality of multiply-accumulate (MAC) units coupled to the shift register and the MUX and configured to:
receive the first plurality of data values from the shift register; and
receive the second plurality of data values and the third plurality of data values from the MUX;
wherein the MUX is configured to:
provide the second plurality of data values to the plurality of MAC units during a first portion of a duration of time; and
provide the third plurality of data values to the plurality of MAC units during a second portion of the duration of time; and
wherein the plurality of MAC units are configured to:
perform a first plurality of multiplication operations utilizing the first plurality of data values and the second plurality of data values; and
perform a second plurality of multiplication operations utilizing the first plurality of data values and the third plurality of data values.

19. The apparatus of claim 18, further comprising a first bank and a second bank, and wherein:
the MUX is configured to receive the second plurality of data values from the first bank; and
the MUX is configured to receive the third plurality of data values from the second bank.

20. The apparatus of claim 18, wherein the MUX is configured to:
receive the first plurality of data values during the first portion of the duration of time; and
receive the second plurality of data values during the second portion of the duration of time.
